(19) United States
(12) Patent Application Publication
(10) Pub. No.: US 2014/0085409 A1
(43) Pub. Date: Mar. 27, 2014

(54) WIDE FOV CAMERA IMAGE CALIBRATION AND DE-WARPING

(71) Applicant: GM GLOBAL TECHNOLOGY OPERATIONS LLC, DETROIT, MI (US)

(72) Inventors: Wende Zhang, Troy, MI (US); Jinsong Wang, Troy, MI (US); Bakhtiar Brian Litkouhi, Washington, MI (US)

(73) Assignee: GM GLOBAL TECHNOLOGY OPERATIONS LLC, DETROIT, MI (US)

(21) Appl. No.: 13/843,978

(22) Filed: Mar. 15, 2013

Related U.S. Application Data
(60) Provisional application No. 61/705,534, filed on Sep. 25, 2012.

(51) Int. Cl. H04N 5/232

(52) U.S. Cl. CPC H04N 5/23238
USPC 348/36

(57) ABSTRACT

A system and method for providing calibration and de-warping for ultra-wide FOV cameras. The method includes estimating intrinsic parameters such as the focal length of the camera and an image center of the camera using multiple measurements of the near optical axis object points and a pinhole camera model. The method further includes estimating distortion parameters of the camera using an angular distortion model that defines an angular relationship between an incident optical ray passing an object point in an object space and an image point on an image plane that is an image of the object point on the incident optical ray. The method can include a parameter optimization process to refine the parameter estimation.

### CROSS-REFERENCE TO RELATED APPLICATIONS

This application claims the benefit of the priority date of U.S. Provisional Patent Application Ser. No. 61/705,534, titled, Wide FOV Camera Image Calibration and De-Warping, filed Sep. 25, 2012.

### BACKGROUND OF THE INVENTION

1. Field of the Invention

This invention relates generally to a system and method for calibrating and de-warping a wide field-of-view (FOV) camera and, more particularly, to a system and method for calibrating and de-warping an ultra-wide FOV vehicle camera, where the method first estimates a focal length of the camera and an optical center of the camera image plane and then identifies distortion parameters using an angular distortion estimation model.

2. Discussion of the Related Art

Modern vehicles generally include one or more cameras that provide back-up assistance, take images of the vehicle driver to determine driver drowsiness or attentiveness, provide images of the road as the vehicle is traveling for collision avoidance purposes, provide structure recognition, such as roadway signs, etc. For those applications where graphics are overlaid on the camera images, it is critical to accurately calibrate the position and orientation of the camera with respect to the vehicle. Camera calibration typically involves determining a set of parameters that relate camera image coordinates to vehicle coordinates and vice versa. Some camera parameters, such as camera focal length, optical center, etc., are stable, while other parameters, such as camera orientation and position, are not. For example, the height of the camera depends on the load of the vehicle, which will change from time to time. This change can cause overlaid graphics of vehicle trajectory on the camera image to be inaccurate.

Current rear back-up cameras on vehicles are typically wide FOV cameras, for example, a 135° FOV. Wide FOV cameras typically provide curved images that cause image distortion around the edges of the image. Various approaches are known in the art to provide distortion correction for the images of these types of cameras, including using a model based on a pinhole camera and models that correct for radial distortion by defining radial parameters.

It has been proposed in the art to provide a surround view camera system on a vehicle that includes a front camera, a rear camera and left and right side cameras, where the camera system generates a top-down view of the vehicle and surrounding areas using the images from the cameras, and where the images overlap each other at the corners of the vehicle. The top-down view can be displayed for the vehicle driver to see what is surrounding the vehicle for back-up, parking, etc. Further, future vehicles may not employ rearview mirrors, but may instead include digital images provided by the surround view cameras.

In order to provide a surround view completely around the vehicle with a minimal number of cameras, available wide FOV cameras having a 135° FOV will not provide the level of coverage desired, and thus, the cameras will need to be ultra-wide FOV cameras having a 180° or greater FOV. These types of ultra-wide FOV cameras are sometimes referred to as fish-eye cameras because their image is significantly curved or distorted. In order to be effective for vehicle back-up and surround view applications, the distortions in the images need to be corrected.

### SUMMARY OF THE INVENTION

In accordance with the teachings of the present invention, a system and method are disclosed for providing calibration and de-warping for ultra-wide FOV cameras. The method includes estimating intrinsic parameters such as the focal length of the camera and an image center of the camera using multiple measurements of the near optical axis object points and a pinhole camera model. The method further includes estimating distortion parameters of the camera using an angular distortion model that defines an angular relationship between an incident optical ray passing an object point in an object space and an image point on an image plane that is an image of the object point on the incident optical ray. The method can include a parameter optimization process to refine the parameter estimation.

Additional features of the present invention will become apparent from the following description and appended claims, taken in conjunction with the accompanying drawings.

### BRIEF DESCRIPTION OF THE DRAWINGS

FIG. 1 is an illustration of a vehicle including a surround view camera system having multiple cameras;

FIG. 2 is an illustration for a pinhole camera model;

FIG. 3 is an illustration for a non-severe radial distortion camera correction model;

FIG. 4 is an illustration for a severe radial distortion camera correction model;

FIG. 5 is an illustration for an angular distortion camera model;

FIG. 6 is an illustration of a camera system for estimating a focal length and an optical center for a camera;

FIG. 7 is an illustration showing how an optical center of a camera image plane is determined using the camera system shown in FIG. 6;

FIG. 8 is an illustration showing how a camera focal length is estimated using the camera system shown in FIG. 6;

FIG. 9 is an illustration of a camera system for determining an angular distortion estimation;

FIG. 10 is a front view of the camera system shown in FIG. 9 illustrating the radial distortion measurement process;

FIG. 11 is an illustration of a first camera rotation axis;

FIG. 12 is an illustration of a second camera rotation axis; and

FIG. 13 is an illustration of a combined camera rotation axis.

### DETAILED DESCRIPTION OF THE EMBODIMENTS

The following discussion of the embodiments of the invention directed to a system and method for calibrating and de-warping a camera is merely exemplary in nature, and is in no way intended to limit the invention or its applications or uses. For example, the present invention has application for calibrating and de-warping a vehicle camera. However, as will be appreciated by those skilled in the art, the present invention will have application for correcting distortions in other cameras.

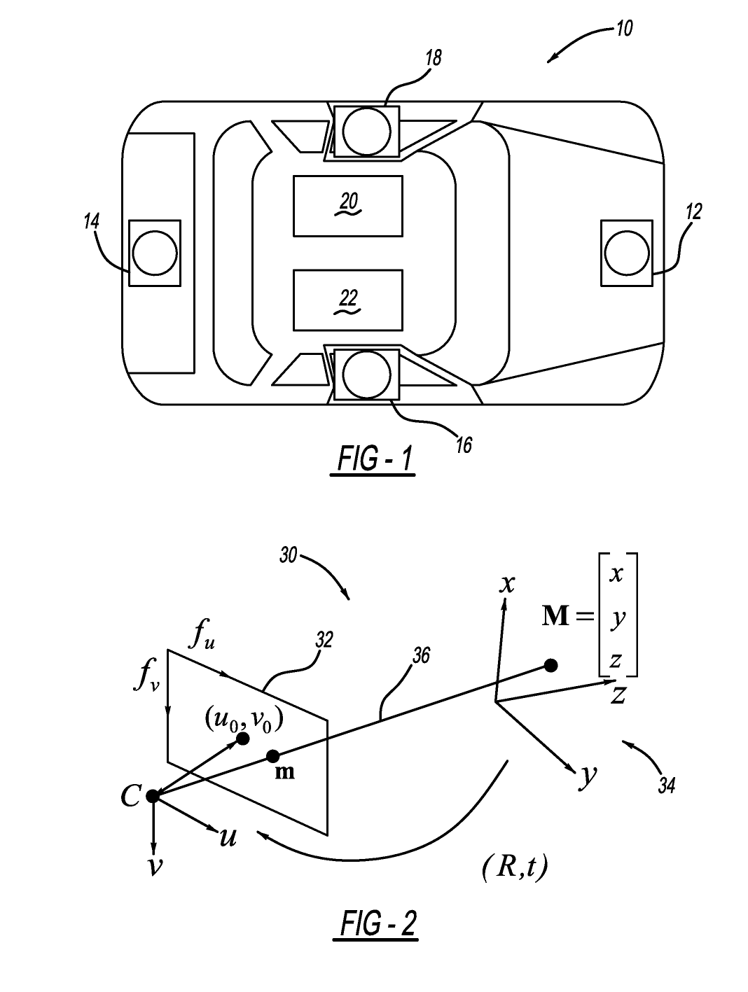

FIG. 1 is an illustration of a vehicle 10 that includes a surround view camera system having a front-view camera 12, a rear-view camera 14, a right-side view camera 16 and a left-side view camera 18. The cameras 12-18 can be any camera suitable for the purposes described herein, many of which are known in the automotive art, that are capable of receiving light, or other radiation, and converting the light energy to electrical signals in a pixel format using, for example, charged coupled devices (CCD). The cameras 12-18 generate frames of image data at a certain data frame rate that can be stored for subsequent processing. The cameras 12-18 can be mounted within or on any suitable structure that is part of the vehicle 10, such as bumpers, facie, grill, side-view mirrors, door panels, etc., as would be well understood and appreciated by those skilled in the art. In one non-limiting embodiment, the side cameras 16 and 18 are mounted under the side view mirrors and are pointed downwards. Image data from the cameras 12-18 is sent to a processor 20 that processes the image data to generate images that can be displayed on a vehicle display 22. For example, as mentioned above, it is known in the art to provide a top-down view of a vehicle that provides images near and on all sides of the vehicle.

The present invention proposes an efficient and effective camera calibration and de-warping process for ultra-wide FOV cameras that employs a simple two-step approach and offers small calibration errors using direct measurements of radial distortions for calibration and a better modeling approach for radial distortion correction. The proposed calibration approach provides effective surround view and dynamic rearview mirror functions with an enhanced de-warping operation and a dynamic guideline overlay feature for ultra-wide FOV cameras. Camera calibration as used herein refers to estimating a number of camera parameters including both intrinsic and extrinsic parameters. The intrinsic parameters include focal length, optical center, radial distortion parameters, etc., and extrinsic parameters include camera location, camera orientation, etc.

Models are known in the art for mapping objects in the world space to an image sensor plane of a camera to generate an image. One model known in the art is referred to as a pinhole camera model that is effective for modeling the image for narrow FOV cameras, such as less than 20°, where the model projects the object being imaged to the image sensor plane of the camera. The pinhole camera model is defined as:

$$\underbrace{S [ \begin{matrix}u \\ v \\ 1\end{matrix} ] =} \underbrace{[ \begin{matrix}{f}_{u} & γ & {u}_{c} \\ 0 & {f}_{v} & {v}_{c} \\ 0 & 0 & 1\end{matrix} ]}_{A} \underbrace{[ \begin{matrix}{r}_{1} & {r}_{2} & {r}_{3} & t\end{matrix} ]}_{[ \begin{matrix}R & t\end{matrix} ]} \underbrace{[ \begin{matrix}x \\ y \\ z \\ 1\end{matrix} ]} \qquad ( 1 )$$

FIG. 2 is an illustration 30 for the pinhole camera model and shows a two-dimensional camera image plane 32 defined by coordinates u, v, and a three-dimensional object space 34 defined by world coordinates x, y and z. The distance from a focal point C to the image plane 32 is the focal length f of the camera and is defined by focal parts fᵤ and fᵥ. A perpendicular line from the point C to the principle point of the image plane 32 defines the image center of the plane 32 designated by u₀,v₀. In the illustration 30, an object point M in the object space 34 is mapped to the image plane 32 at point m, where the coordinates of the image point m is u_{c}, v_{c}.

Equation (1) includes the parameters that are employed to provide the mapping of point M in the object space 34 to point m in the image plane 32. Particularly, intrinsic parameters include fᵤ, fᵥ, u_{c}, v_{c} and Y and extrinsic parameters include a 3 by 3 matrix R for the camera rotation and a 3 by 1 translation vector t from the image plane 32 to the object space 34. The parameter Y represents a skewness of the two image axes that is typically negligible, and is often set to zero. A detailed discussion of how the remaining intrinsic parameters and extrinsic parameters are calculated will be provided below.

Because the pinhole camera model is based on a point in the image plane 32, the model does not include parameters for correction of radial distortion, i.e., curvature of the image, and thus the pinhole model is only effective for narrow FOV cameras. For wide FOV cameras that do have curvature of the image, the pinhole camera model alone is typically not suitable.

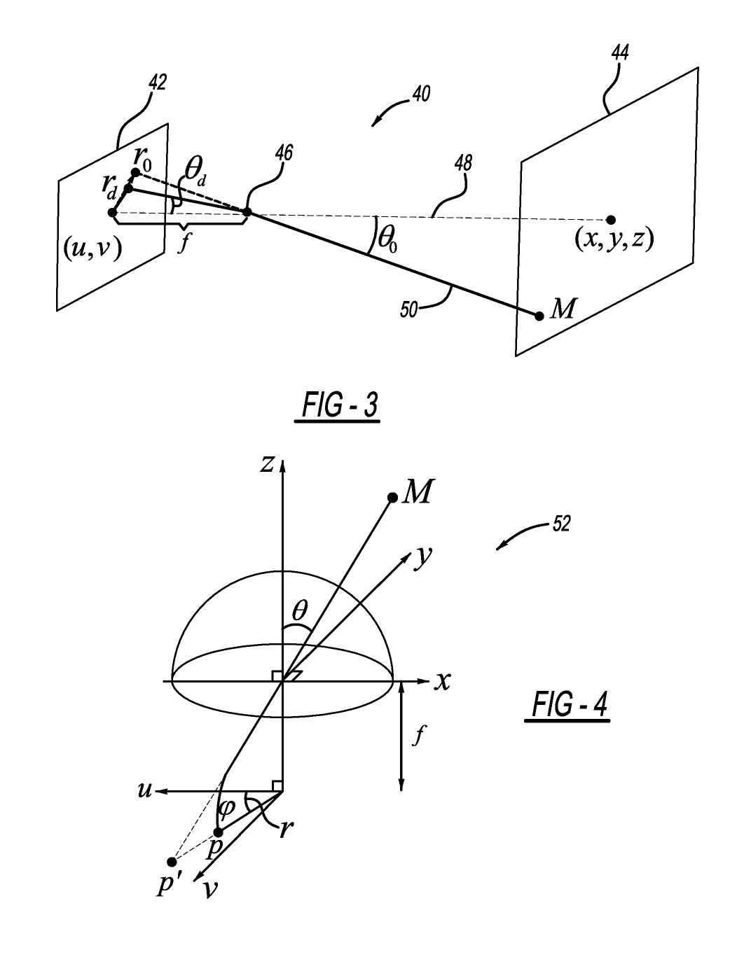

FIG. 3 is an illustration 40 for a radial distortion correction model, shown in equation (2) below, sometimes referred to as the Brown-Conrady model, that provides a correction for non-severe radial distortion for objects imaged on an image plane 42 from an object space 44. The focal length f of the camera is the distance between point 46 and the center of the image plane 42 along line 48 perpendicular to the image plane 42. In the illustration 40, an image location r_{c}, at the intersection of line 50 and the image plane 42 represents a virtual image point m₀ of the object point M if a pinhole camera model is used. However, since the camera image has radial distortion, the real image point m is at location r_{d}, which is the intersection of the line 48 and the image plane 42. The values r₀ and r_{d} are not points, but are the radial distance from the image center u₀,v₀ to the image points m₀ and m.

r_{d}=r₀(1+k₁·r₀²+k₂·r₀⁴+k₃·r₀⁶+ . . . ) (2)

The point r₀ is determined using the pinhole model discussed above and includes the intrinsic and extrinsic parameters mentioned. The model of equation (2) is an even order polynomial that converts the point r₀ to the point r_{d} in the image plane 42, where k is the parameters that need to be determined to provide the correction, and where the number of the parameters k define the degree of correction accuracy. The calibration process is performed in the laboratory environment for the particular camera that determines the parameters k. Thus, in addition to the intrinsic and extrinsic parameters for the pinhole camera model, the model for equation (2) includes the additional parameters k to determine the radial distortion.

The non-severe radial distortion correction provided by the model of equation (2) is typically effective for wide FOV cameras, such as 135° FOV cameras. However, for ultra-wide FOV cameras, i.e., 180° FOV, the radial distortion is too severe for the model of equation (2) to be effective. In other words, when the FOV of the camera exceeds some value, for example, 140°-150°, the value rₒ goes to infinity when the angle θ approaches 90°. For ultra-wide FOV cameras, a severe radial distortion correction model shown in equation (3) has been proposed in the art to provide correction for severe radial distortion.

FIG. 4 is an illustration 52 for a severe correction distortion model shown in equation (3) below, where equation (3) is an odd order polynomial, and includes a technique for providing a radial correction of the point r₀ to the point r_{d} in the image plane 42. As above, the image plane is designated by the coordinates u, v and the object space is designated by the world coordinates x, y, z. Further, θ is the optical axis. In the illustration 52, point p′ is the virtual image point of the object point M using the pinhole camera model, where its radial distance r₀ may go to infinity when θ approaches 90°. Point p at radial distance r is the real image of point M, which has the radial distortion that can be modeled by equation (3).

The values p in equation (3) are the parameters that are determined. Thus, the incidence angle θ is used to provide the distortion correction based on the calculated parameters during the calibration process.

r_{d}=p₁·θ₀+p₂·θ₀³+p₃·θ₀⁵+ . . . (3)

Various techniques are known in the art to provide the estimation of the parameters k for the model of equation (2) or the parameters p for the model of equation (3). For example, in one embodiment a checkerboard pattern is used and multiple images of the pattern are taken, where each point in the pattern between adjacent squares is identified. Each of the points and the squares in the checkerboard pattern are labeled and the location of each point is identified in both the image plane and the object space in world coordinates. Each of the points in the checkerboard pattern for all of the multiple images is identified based on the location of those points, and the calibration of the camera is obtained.

Although the model of equation (3) has been shown to be effective for ultra-wide FOV cameras to correct for radial distortion, improvements can be made to provide a faster calibration with fewer calibration errors.

As mentioned above, the present invention proposes providing a distortion correction for an ultra-wide FOV camera based on angular distortion instead of radial distortion. Equation (4) below is a recreation of the model of equation (3) showing the radial distortion r. Equation (5) is a new model for determining a distortion angle σ as discussed herein and is a complete polynomial. The relationship between the radial distortion r and the distortion angle σ is given by equation (6). The radial distortion r is computed from the image point p (u_{d}, v_{d}), and it is converted to the distortion angle σ using equation (6), where equation (6) is the rectilinear projection used in the pinhole model.

r=h(θ)=p₁·θ+p₂·θ³+p₃·θ⁵+ . . . (4)

[symbol]

=g(θ)=p₁·θ+p₂·θ²+p₃·θ⁵+ . . . (5)

tan( [symbol] )=r/f (6)

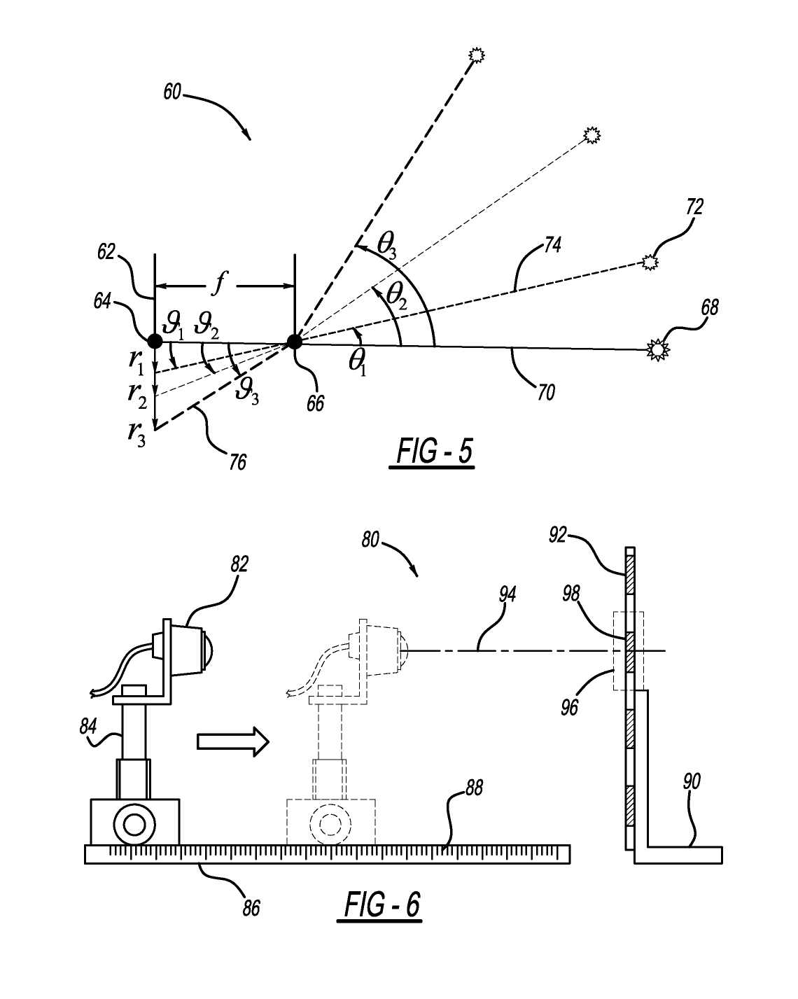

FIG. 5 is an illustration 60 for the model of equation (5) showing a relationship between the distortion angle [symbol] and the radial distortion r. The illustration 60 shows an image plane 62 having an image center 64, where the image plane 62 has a focal length f at point 66. A point light source 68 in the object space defines a line 70 through the focal point 66 to the image center 64 in the image plane 62. The point light source 68 is moved to other locations, represented by locations 72, by rotating the camera to provide other incident angles, as discussed herein, particularly lines 74 that go through the focal point 66 relative to the line 70 define angles θ₁, θ₂ and θ₃. Lines 76 from the focal point 66 to the distorted image points at r₁, r₂ and r₃ in the image plane 62 define distortion angles [symbol] ₁, [symbol] ₂ and [symbol] ₃. The angles [symbol] ₁, [symbol] ₂ and [symbol] ₃ between the line 70 and the distorted image points at r₁, r₂ and r₃ provide the angular distortion as illustrated by the model in equation (5). Thus, if the image focal length f and the image center 64 are known, the radial distortion r and the distortion angle [symbol] have a one-to-one correspondence and can be calculated. Thus, based on the illustration 60:

[symbol]

=f_{distort}′(θ₀) (7)

As will be discussed in detail below, the present invention proposes at least a two-step approach for calibrating a camera using angular distortion and providing image de-warping. The first step includes estimating the focal length and the image center of an image plane for a particular camera and then identifying the angular distortion parameters p using the angular distortion model of equation (5).

FIG. 6 is a side view of a camera system 80 that is employed in a laboratory environment to determine the focal length and image center of an image plane for a camera 82. The camera 82 is mounted to a camera stand 84 that in turn is slidably mounted to a linear stage 86, where the position of the camera 82 on the stage 86 can be determined by a scale 88 on the stage 86. The stage 86 is positioned relative to a target stand 90 on which a checkerboard target 92 is mounted relative to the camera 82. A small region 96 on the target 92 around an optical axis 94 of the camera 82 is defined, where one of the squares 98 within the checkerboard target 92 is isolated within the region 96. Because the region 96 is small and provides a narrow FOV relative to the optical axis 94, the pinhole camera model can be employed to determine the parameters effective for determining the focal length and the image center of the image plane for the camera 82. It is noted that the estimation described only uses four near optical axis points for the focal length and image center parameter measurements. Further, it is assumed that the camera's optical axis is parallel to the linear stage movement orientation and is perpendicular to the target 92 by providing precise mounting. The points near the optical axis have low distortion.

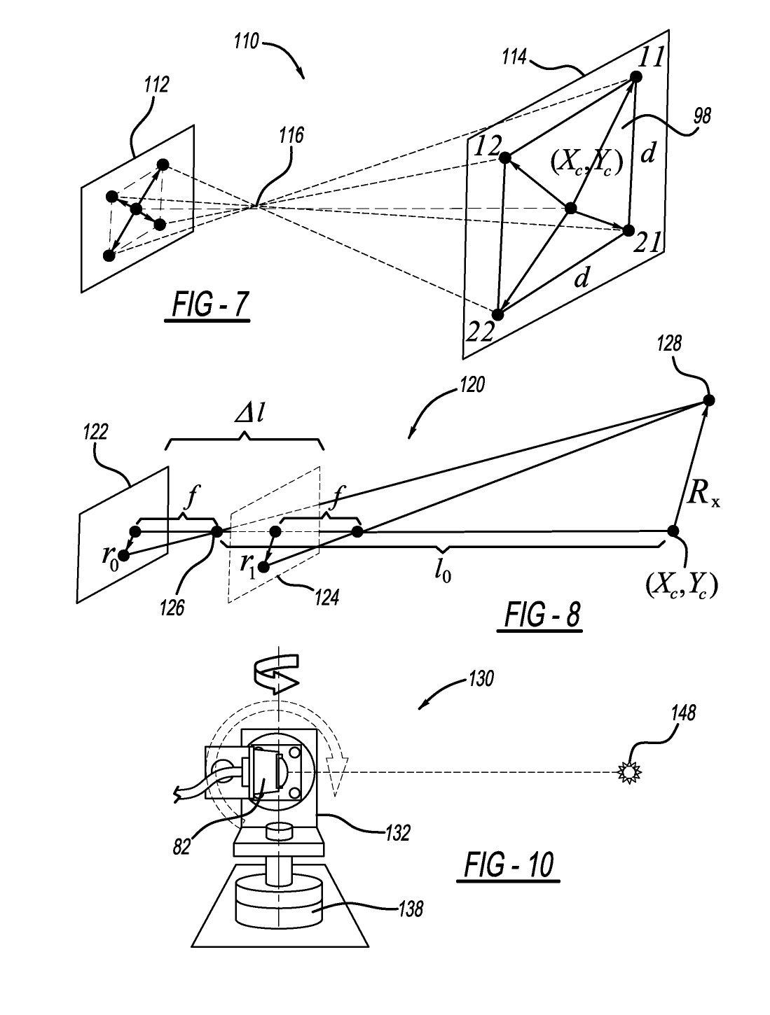

FIG. 7 is an illustration 110 of the pinhole camera model and includes an image plane 112 and a target plane 114, where the square 98 in the target 92 is shown in the target plane 114. Each corner of the square 98, represented by 11, 12, 21 and 22, near the optical axis 94 is mapped to the image plane 112 using the pinhole camera model through focal point 116. Therefore, the distance from the image of the square 98 in the image plane 112 to the point 116 provides a focal point for that image, where the values X_{c}, Y_{c} define the extrinsic object space center point on the checker board.

In order to accurately provide the focal length and image center estimation parameters, multiple images are taken of the square 98, where the camera 82 is moved along the stage 86 to provide the additional images. FIG. 8 is an illustration 120 showing multiple image planes 122 and 124 as the camera 82 is moved on the stage 86. The focal point 126 of the image plane 122 is shown and one of the corners of the square 98 at point 128 is shown. The value l₀ is the distance from the focal point 126 to the object space center point X_{c}, Y_{c}.

As mentioned, the intrinsic parameters fᵤ, fᵥ, u_{c}, v_{c} and the extrinsic parameters including the rotation matrix R and the translation vector t can be obtained in any suitable manner consistent with the discussion herein. Suitable examples include employing a maximum likelihood estimation or a least-squares estimation. The least-squares estimation process is illustrated in equations (8)-(10) where the values in these equations can be found in the discussion herein and in the figures.

$$\begin{matrix}\{ \begin{matrix}\frac{{r}_{0}}{f} = \frac{{R}_{X}}{{l}_{0}} \\ \frac{{r}_{1}}{f} = \frac{{R}_{X}}{{l}_{0} - Δ l}\end{matrix} ⇒ \frac{{r}_{1} - {r}_{0}}{{r}_{1}} = \frac{Δ l}{{l}_{0}} ⇒ \{ \begin{matrix}\frac{Δ u}{{u}_{1} - {u}_{c}} = \frac{Δ l}{{l}_{0}} \\ \frac{Δ v}{{v}_{1} - {v}_{c}} = \frac{Δ l}{{l}_{0}}\end{matrix} ⇒ \{ \begin{matrix}{u}_{c} + 0 + \frac{Δ u}{Δ l} \cdot {l}_{0} = {u}_{1} \\ 0 + {v}_{c} + \frac{Δ v}{Δ l} \cdot {l}_{0} = {v}_{1}\end{matrix} ⇒ [ \begin{matrix}{u}_{c} \\ {v}_{c} \\ {l}_{0}\end{matrix} ] & ( 8 ) \\ \begin{matrix}\begin{matrix}{r}_{ij} / f = {R}_{ij} / {l}_{0} ⇒ {r}_{ij} / {r}_{mn} = {R}_{ij} / {R}_{mn} \\ {X}_{i 2} - {X}_{i 1} = d\end{matrix} \\ {Y}_{2 j} - {Y}_{1 j} = d\end{matrix} \} ⇒ \{ \begin{matrix}\frac{{u}_{i 1} - {u}_{c}}{{u}_{i 2} - {u}_{c}} = \frac{{X}_{C}}{d - {X}_{C}} , {X}_{i 1} = 0 \\ \frac{{v}_{1 j} - {v}_{c}}{{v}_{2 j} - {v}_{c}} = \frac{{Y}_{C}}{d - {Y}_{C}} , {Y}_{1 j} = 0\end{matrix} ⇒ [ \begin{matrix}{X}_{C} \\ {Y}_{C}\end{matrix} ] & ( 9 ) \\ {r}_{ij} / f = {R}_{ij} / {l}_{0} ⇒ \{ \begin{matrix}\frac{{u}_{ij} - {u}_{c}}{{f}_{u}} = \frac{{X}_{ij} - {X}_{C}}{{l}_{0}} \\ \frac{{v}_{ij} - {v}_{c}}{{f}_{v}} = \frac{{Y}_{ij} - {Y}_{C}}{{l}_{0}}\end{matrix} ⇒ [ \begin{matrix}{f}_{u} \\ {f}_{v}\end{matrix} ] & ( 10 )\end{matrix}$$

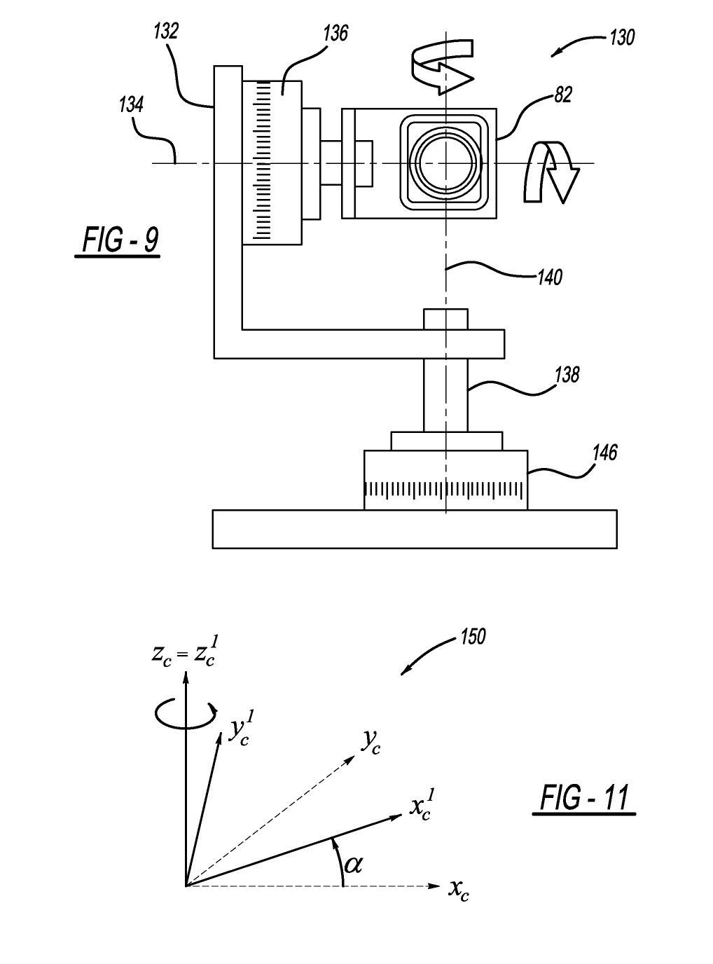

Once the focal length and image center parameters are identified, the next step is to identify the distortion. To do this, the camera 82 is mounted to a two angle rotational stage. FIG. 9 is a side view and FIG. 10 is a front view of an optical system 130 for calibrating the camera 82. The camera 82 is mounted to a first rotational stage 132 along an optical axis 134, where the stage 132 includes an angular measurement scale 136. The stage 132 is mounted to a second rotational stage 138 that rotates the camera 82 in a perpendicular direction along optical axis 140, where the two optical axes 134 and 140 cross at the center of the camera 82, as shown. The second rotational stage 138 also includes an angular measurement scale 146. A point light source 148, such as an LED, is included in the system 130 to represent the point M.

The incident angle θ is calculated from two directly measured rotation angles using the system 130. The rotational stages 132 and 138 are set at various angles for each measurement, where the stage 132 provides an angle α rotational measurement and the stage 116 provides an angle β rotational measurement on the scales 136 and 146. The angles α and β are converted to a single angle measurement discussed below, represented by θ₁, θ₂ and θ₃, as shown in FIG. 5). The angle θ is the angle relative to the point source 148 and the point in world coordinates x, y, z and the angle σ is the corresponding distorted angle in image coordinates.

FIG. 11 is an illustration 150 of a coordinate system for the first rotational stage 132 in world coordinate x_{c}, y_{c}, z_{c}, where the axes x_{c}¹, y_{c}¹, z_{c}¹ are the position of the stage 132 when the camera 82 is rotated to a first measurement point represented by the angle α.

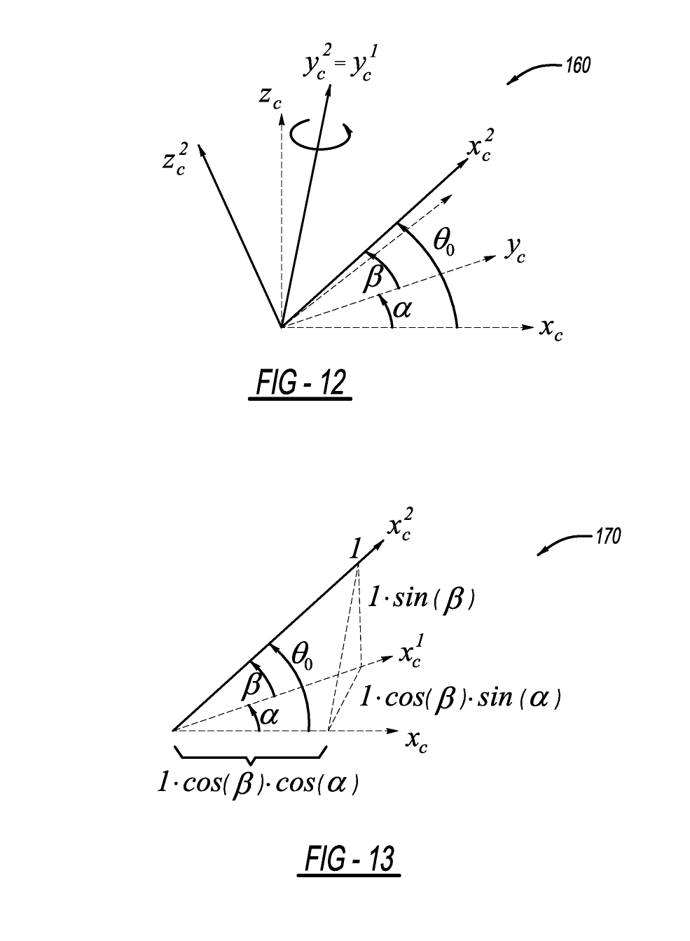

FIG. 12 is an illustration 160 of three coordinate systems overlapping including a third coordinate system x_{c}², y_{c}², z_{c}² showing the rotation of the second rotational stage 138 for the angle β rotational measurement.

FIG. 13 is an illustration 170 of the angle θ₀ for the combination of the angles α and β as identified by equation (11).

θ₀=arccos(1·cos(β)·cos(α)) (11)

The radial distance r_{d} is calculated from the image point u, v of the point source for a series of measurement images using equations (12)-(16) below. The distortion angle σ for each distance r_{d} is determined using the pinhole camera model and equations (6) and (7). Once a number of distortion angles [symbol] and incident angles θₒ are obtained for the several measurements, that number of the angular distortion parameters p₁, p₂, p₃, . . . can be solved using numerical analysis methods and equation (5).

r_{d}={square root over (((u−u_{c})/s)²+(v−v_{c})²)} (12)

s=fᵤ/fᵥ (13)

f=fᵥ (14)

φ=arctan(s·(v−v_{c})/(u−u_{c})) (15)

θ_{d}=arctan(r_{d}/f) (16)

Once the experimental procedures discussed above for estimating the focal length and the image center of the camera and estimating the distortion parameters are complete, it may be desirable to provide parameter optimization in an offline calculation. Parameter optimization is optional depending on whether the parameter estimation accuracy that is desired has been achieved, where the parameter estimation accuracy for some applications prior to parameter optimization may be sufficient. If parameter optimization is required, offline calculations are performed that utilize the estimated parameters for all of the points on the checkerboard target 92 to refine the estimated focal length and image center as well as estimating the camera mounting imperfections, such as rotation from the assumed perpendicular-to-target orientation. The estimated distortion parameters are then refined using the refined image center and focal length. The parameter refinement is implemented by minimizing an objective function, such as a point re-projection error function. These steps can then be iteratively repeated until the parameters converge, the objection function reaches a threshold, or the iteration times reach a predefined value.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for calibrating and de-warping a camera, said method comprising:
estimating a focal length of the camera;
estimating an image center of an image plane of the camera;
providing an angular distortion model that defines an angular relationship between an incident optical ray passing an object point in an object space and an image point on the image plane that is an image of the object point on the incident optical ray; and
estimating distortion parameters in the distortion model.

2. The method according to claim 1 further comprising optimizing the estimated parameters to refine the parameter estimation.

3. The method according to claim 2 wherein optimizing the estimated parameters includes using initial estimates of the focal length and the image center of the camera and the distortion parameters for multiple points on a target to refine the estimate of the focal length and the image center and a camera position estimation, and using the refined focal length and image center estimation to refine the estimation of the distortion parameters, and wherein the refinement of the estimates of the focal length, the image center, the camera position and the distortion parameters are performed iteratively until a predetermined value is reached.

4. The method according to claim 1 wherein estimating a focal length and an image center of an image plane of the camera includes mounting the camera to a translational stage and moving the camera along the stage to different locations, mounting a checkerboard target to a target stage positioned relative to the translational stage, defining a target region on the target around an optical axis of the camera that includes squares in the checkerboard target and using the pinhole camera model and positions of corners of the squares in images acquired at the different locations along the stage to determine the focal length and the image center.

5. The method according to claim 4 further comprising determining camera extrinsic parameters.

6. The method according to claim 5 wherein the camera extrinsic parameters include a rotational matrix of the camera and a translational vector of the camera in terms of object space coordinates.

7. The method according to claim 6 wherein the translational vector is determined using a vector from a camera aperture point to an object space center point.

8. The method according to claim 6 wherein the rotational matrix and the translational vector are determined by the pinhole camera model.

9. The method according to claim 4 wherein the target region satisfies the pinhole camera model and a perspective rectilinear projection condition.

10. The method according to claim 1 wherein estimating distortion parameters includes mounting the camera to a two-axis rotational stage that rotates the camera in two perpendicular rotational directions and calculating a combined angle based on the combination of the two rotational angles.

11. The method according to claim 10 wherein determining angular distortion parameters includes determining a combined incident angle for a plurality of two rotational angles.

12. The method according to claim 1 wherein providing an angular distortion model includes using the equation: [symbol]
=g(θ)=p₁·θ+p₂·θ²+p₃·θ⁵+ . . .
where [symbol] is the distortion angle, θ is an incident angle of the object point and p is the angular distortion parameters.

13. The method according to claim 1 wherein the camera is a wide view or ultra-wide view camera.

14. The method according to claim 13 wherein the camera has a 180° or greater field-of-view.

15. The method according to claim 13 wherein the camera is a vehicle camera.

16. A method for calibrating and de-warping a wide view or ultra-wide view vehicle camera, said method comprising:
estimating a focal length and an image center of an image plane of the camera, wherein estimating a focal length and an image center of an image plane of the camera includes mounting the camera to a translational stage and moving the camera along the stage to different locations, mounting a checkerboard target to a target stage positioned relative to the translational stage, defining a target region on the target around an optical axis of the camera that includes squares in the checkerboard target and using the pinhole camera model and positions of corners of the squares in images acquired at the different locations along the stage to determine the focal length and the image center;
providing an angular distortion model that defines an angular relationship between an incident optical ray passing an object point in an object space and an image point on the image plane that is an image of the object point on the incident optical ray; and
estimating distortion parameters in the distortion model, wherein estimating distortion parameters includes mounting the camera to a two-axis rotational stage that rotates the camera in two perpendicular rotational directions and calculating a combined angle based on the combination of the two rotational angles.

17. The method according to claim 16 further comprising determining camera extrinsic parameters, wherein the camera extrinsic parameters include a rotational matrix of the camera and a translational vector of the camera in terms of object space coordinates, and wherein the translational vector is determined using a vector from a camera aperture point to an object space center point, and wherein the rotational matrix and the translational vector are determined by the pinhole camera model.

18. The method according to claim 16 wherein determining angular distortion parameters includes determining a combined incident angle for a plurality of two rotational angles.

19. The method according to claim 16 wherein providing an angular distortion model includes using the equation: [symbol]
=g(θ)=p₁·θ+p₂·θ²+p₃·θ⁵+ . . .
where σ is the distortion angle, θ is an incident angle of the object point and p is the angular distortion parameters.

20. A system for calibrating and a de-warping a camera, said system comprising:
means for estimating a focal length of the camera;
means for estimating an image center of an image plane of the camera;
means for providing an angular distortion model that defines an angular relationship between an incident optical ray passing an object point in an object space and an image point on the image plane that is an image of the object point on the incident optical ray; and
means for estimating distortion parameters in the distortion model.
